(19) United States
(12) Patent Application Publication
(10) Pub. No.: US 2024/0166565 A1
(43) Pub. Date: May 23, 2024

(54) Fiber Cement-Gypsum Compositions for Building Elements

(71) Applicant: James Hardie Technology Limited, Dublin (IE)

(72) Inventors: Joe Peng, Fontana, CA (US); Basil Naji, Fontana, CA (US); Mehmet Donmez, Fontana, CA (US); Farshad Motamedi, Fontana, CA (US); Hui Li, Fontana, CA (US)

(21) Appl. No.: 18/281,422

(22) PCT Filed: Mar. 18, 2022
(86) PCT No.: PCT/US2022/020904

§ 371 Date: Sep. 11, 2023

Related U.S. Application Data
(60) Provisional application No. 63/163,296, filed on Mar. 19, 2021.

(51) Int. Cl. C04B 28/14; C04B 14/06; C04B 14/10; C04B 14/18; C04B 14/28; C04B 16/06; C04B 18/14; C04B 18/24

(52) U.S. Cl. CPC C04B 28/14; C04B 14/06; C04B 14/106; C04B 14/185; C04B 14/28; C04B 16/0633; C04B 18/146; C04B 18/24

(57) ABSTRACT

A fiber cement gypsum composite formulation comprising a binder, reinforcing fibers and a pozzolanic material wherein the binder comprises a gypsum-hydraulic cement mix, wherein gypsum is calcium sulfate dihydrate and the hydraulic cement is Portland cement.

### CROSS-REFERENCE TO RELATED APPLICATIONS

This application claims the benefit of U.S. Provisional Application Ser. No. 63/163,296, filed 19 Mar. 2021, entitled “FIBER CEMENT-GYPSUM COMPOSITIONS FOR BUILDING ELEMENTS” which is hereby incorporated by reference in its entirety and for all purposes.

### FIELD

The present disclosure generally relates to building elements suitable for use in construction. In particular, the disclosure relates to fiber cement-gypsum compositions for use in building elements suitable for use in a building envelope.

Whilst the embodiments disclosed herein have been developed primarily for use as building elements and will be described hereinafter with reference to this application, it will be appreciated that the embodiments are not limited to this particular field of use and that the embodiments can be used in any suitable field of use known to the person skilled in the art.

### BACKGROUND

Any discussion of the prior art throughout the specification should in no way be considered as an admission that such prior art is widely known or forms part of the common general knowledge in the field.

Fiber cement is a composite material that is suitable for use as a building element in both internal and external environments. It is commonly used as a cladding material in the form of building sheets, panels, planks, roofing and/or as a tile underlayment in wet areas. Fiber cement typically comprises hydraulic cement which is reinforced with reinforcing fibers. The reinforcing fibers are uniformly distributed through the cementitious matrix to achieve the desired level of reinforcement which in turn leads to the strength and durability required in the fiber cement composite material. The strength and durability of fiber cement composite material provide significant structural advantages, particularly when the material is used in areas with elevated activity levels whereby the strength and durability of the material provides protection in areas of increased risk of incidental contact, wear, and damage.

Gypsum boards primarily comprise calcium sulfate dihydrate. Gypsum boards are known to provide desired thermal, acoustic and fire performance properties when used as building elements, however it is also known that gypsum containing materials are generally not water resistant. Gypsum boards are known to absorb water which ultimately leads to disintegration of the material. Consequently, gypsum materials are usually not used as building elements where water is likely to be present, for example, as exterior cladding materials or as backer boards for wet areas or floor underlayment's.

In residential or multi-family housing, gypsum board is often used in wall assemblies to provide a degree of fire resistance, whereby the gypsum board limits heat transfer from one room to the next in the event of a fire. This is possible because the molecular or crystalline water in the gypsum material absorbs the heat energy of the fire as it dissociates from the gypsum (Calcium sulfate) crystal structure before it evaporates off. Thus, slowing down the rate of heat transfer from one side of the wall where the fire has occurred to the other.

It is often desired that a building envelope achieve a certain structural, thermal, acoustic and fire performance which is not always achievable using either fiber cement building elements or gypsum boards. In some instances, in order to achieve all of the desired performance characteristics it is necessary to use fiber cement building elements in conjunction with gypsum boards in a layered arrangement in a building envelope. Typically, in such instances, one or two layers of gypsum board are positioned between fiber cement building elements and a building substrate, thus the gypsum board is sheltered from external environmental factors and the building envelope achieves the desired thermal, acoustic and fire performance. Commonly, this solution involves multiple installation steps which in turn impacts labor requirements and costs during construction of the building.

Previous attempts to combine cement and gypsum materials to form a building element with improved water resistance have shown limited success due to delayed ettringite formation. Delaying ettringite formation leads to expansion and cracking of the cured composition which leads to deterioration and consequential failure of the combined cement-gypsum building element.

### SUMMARY

It is an object of the present disclosure to overcome or ameliorate at least one of the disadvantages of the prior art, or to provide a useful alternative.

The present disclosure relates generally to a composite material comprising gypsum in the form of calcium sulfate dihydrate, hydraulic cement and reinforcing fibers.

The embodiments have been developed primarily for use as building elements and will be described hereinafter with reference to this application. However, it will be appreciated that the embodiments are not limited to this field of use and that the embodiments can be used in any suitable field of use known to the person skilled in the art.

Accordingly, the present disclosure provides in one embodiment a fiber cement gypsum composite formulation comprising a binder, reinforcing fibers, and a pozzolanic material, wherein the binder comprises a gypsum-cement mix comprising gypsum and a hydraulic cement, wherein the gypsum comprises calcium sulfate dihydrate, and wherein the hydraulic cement comprises Portland cement.

According to the present disclosure there is provided a fiber cement gypsum composite formulation as set out in appended claims 1 to 31. There is also provided a fiber cement gypsum composite article as set out in appended claims 32 to 43 and a method of manufacturing a fiber cement composite article as set out in appended claims 44 to 49.

In one embodiment, the gypsum-cement mix comprises between approximately 50 to 75 weight (wt) % of a total wt % of the fiber cement gypsum composite formulation.

In one embodiment, the gypsum-cement mix comprises any sub-range between approximately 50 wt % and approximately 75 wt % of a total wt % of the fiber cement gypsum composite formulation.

In one embodiment, the gypsum comprises between approximately 30 to 45 wt % of a total wt % of the fiber cement gypsum composite formulation such that the gypsum-cement mix comprises between approximately 50 to 75 wt % of a total wt % of the fiber cement gypsum composite formulation.

In one embodiment, the gypsum comprises any sub-range between approximately 30 to 45 wt % of a total wt % of the fiber cement gypsum composite formulation such that the gypsum-cement mix comprises any suitable sub-range between approximately 50 to 75 wt % of a total wt % of the fiber cement gypsum composite formulation.

In one embodiment, the gypsum comprises 40 wt % of a total wt % of the fiber cement gypsum composite formulation.

In one embodiment, the gypsum comprises 35 wt % of a total wt % of the fiber cement gypsum composite formulation.

In one embodiment, the hydraulic cement comprises approximately 20 to 30 wt % of a total wt % of the fiber cement gypsum composite formulation such that the gypsum-cement mix comprises between approximately 50 to 75 wt % of a total wt % of the fiber cement gypsum composite formulation.

In one embodiment, the hydraulic cement comprises any sub-range between approximately 20 to 30 wt % of a total wt % of the fiber cement gypsum composite formulation such that the gypsum-cement mix comprises any sub-range between approximately 50 to 75 wt % of a total wt % of the fiber cement gypsum composite formulation.

In one embodiment, a wt % ratio of gypsum to hydraulic cement in the gypsum-cement mix ranges between approximately 1:1 and 2:1, more preferably between approximately 1:1, 1.1:1, 1.15:1, 1.16:1, 1.2:1, 1.3:1, 1.4:1, 1.5:1, 1.6:1, 1.7:1, 1.8:1, 1.9:1 and 2:1.

In one embodiment, the reinforcing fibers comprise cellulose fibers.

In one embodiment, the reinforcing fibers comprise between approximately 7 to 10 wt % of a total wt % of the fiber cement gypsum composite formulation.

In one embodiment, the reinforcing fibers comprise cellulose fibers and synthetic fibers.

In one embodiment, the synthetic fibers are polypropylene fibers.

In one embodiment, the reinforcing fibers comprise cellulose fibers and mineral fibers.

In one embodiment, the mineral fibers are basalt fibers.

In one embodiment, the reinforcing fibers comprise approximately 4 wt % of cellulose fibers and approximately 2 wt % synthetic fibers, wherein the synthetic fibers are polypropylene fibers.

In one embodiment, the pozzolanic material comprises metakaolin or silica fume.

In one embodiment, the pozzolanic material comprises between approximately 5 to 11 wt % of a total wt % of the fiber cement gypsum composite formulation.

In one embodiment, the pozzolanic material comprises approximately 5 wt % of a total wt % of the fiber cement gypsum composite formulation.

In one embodiment, the pozzolanic material comprises approximately 7.5 wt % of a total wt % of the fiber cement gypsum composite formulation.

In one embodiment, the pozzolanic material comprises approximately 10 wt % of a total wt % of the fiber cement gypsum composite formulation.

In one embodiment, the fiber cement gypsum composite formulation further comprises a filler material.

In one embodiment, the filler material comprises limestone or silica.

In one embodiment, the filler material comprises between approximately 0 to 31 wt % of a total wt % of the fiber cement gypsum composite formulation.

In one embodiment, the fiber cement gypsum composite formulation further comprises a low-density modifying agent.

In one embodiment, the low-density modifying agent comprises expanded perlite.

In one embodiment, the low-density modifying agent comprises approximately 5 wt % of a total wt % of the fiber cement gypsum composite formulation.

In one embodiment, the low-density modifying agent further comprises approximately 13 to 28 wt % silica relative to a total wt % of the fiber cement gypsum composite formulation.

In one embodiment, the low-density modifying agent further comprises approximately 18 wt % silica relative to a total wt % of the fiber cement gypsum composite formulation.

In one embodiment, an oven dry density of the fiber cement gypsum composite formulation is approximately 1.1 g/cm3.

The present disclosure further provides, a fiber cement gypsum article comprising any one of the preceding fiber cement gypsum composite formulations.

In one embodiment, the fiber cement gypsum article comprising any one of the preceding fiber cement gypsum composite formulations, is a building article. In one exemplary embodiment, the building article is a building panel.

In one embodiment, the fiber cement gypsum article comprising any one of the preceding fiber cement gypsum composite formulations is coated with an intumescent material.

In one embodiment, a fiber cement gypsum article comprising any one of the preceding fiber cement gypsum composite formulations further comprises a smooth or a textured surface.

In one embodiment, the fiber cement gypsum article comprising any one of the preceding fiber cement gypsum composite formulations further comprises an aesthetic finish on at least a section of at least one major face, wherein the aesthetic finish comprises one or more of the group comprising textures, patterns, profiles, visual indicia and/or a decorative finish. In some embodiments, the decorative finish is in the form of an applied coating material including for example, sealer, primer, paint or a digital print. In a further embodiment, the aesthetic finish is applied to at least one surface of the fiber cement gypsum article. In one embodiment, the aesthetic finish is printed onto at least at least one surface of the fiber cement gypsum article. In an alternate embodiment, the aesthetic finish is embossed into at least one surface of the fiber cement gypsum article. In a further embodiment the aesthetic finish is integrally formed in at least one surface of the fiber cement gypsum article. In an alternative embodiment, the aesthetic finish is machined into at least one surface of the fiber cement gypsum article. In a further alternative embodiment, the aesthetic finish comprises a laminated layer which is bonded to at least one surface of the fiber cement gypsum article.

The present disclosure further provides a method for manufacturing a fiber cement gypsum composite article comprising any one of the preceding fiber cement gypsum composite formulations. In one embodiment, the present disclosure provides a fiber cement gypsum composite article which is manufactured using the Hatschek process comprising the steps of
(a) forming a fiber cement gypsum slurry comprising at least a binder, a pozzolanic material and reinforcing fibers.
(b) depositing one or more thin fiber cement gypsum layers using the Hatschek process to form a building article having a desired thickness.

The present disclosure provides that the fiber cement gypsum slurry further optionally comprises one or more of the additional formulation components as set out in the present disclosure.

The present disclosure also provides a fiber cement gypsum composite article that is optionally pressed during the manufacturing process. The present disclosure provides that the fiber cement gypsum article may be pressed before being cured whilst in a ‘so-called’ green sheet state at a pressure range of between approximately 15M Pa and approximately 25 MPa for a period of between approximately 5 mins and approximately 10 mins. In one embodiment, the fiber cement gypsum composite article may be pressed using a hydraulic press. Any other suitable pressing apparatus known to a person skilled in the art can also be used.

The present disclosure further provides that the green sheet fiber cement gypsum composite article may be cured at a temperature of between approximately 60° C. and approximately 80° C., whilst at between approximately 90% and 100% relative humidity for a period of between approximately 18 and approximately 24 hours after the fiber cement gypsum composite article has been manufactured using the Hatschek Process. Optionally in one embodiment of the present disclosure the green sheet fiber cement gypsum composite article may be pre-cured at ambient temperature for a period of approximately 6 and approximately 12 hours before the step of being cured at a temperature of between approximately 60° C. and approximately 80° C., whilst at between approximately 90% and 100% relative humidity for a period of between approximately 18 and approximately 24 hours. The present disclosure further provides that the green sheet fiber cement gypsum composite article is optionally dried for a period of between approximately 30 and approximately 60 minutes at a temperature of between approximately 60° C. and approximately 80° C., whilst at less than approximately 10% relative humidity subsequent to being partially cured at a temperature of between approximately 60° C. and approximately 80° C., whilst at between approximately 90% and 100% relative humidity for a period of between approximately 18 and approximately 24 hours.

It is of course understood that other suitable fiber cement manufacturing processes, such as, for example, Flow-on or Fourdrinier or any other suitable manufacturing process known to the skilled person could also be used to manufacture a fiber cement gypsum composite article comprising any one of the preceding fiber cement gypsum composite formulations. Such manufactured fiber cement gypsum composite articles can also be optionally pressed and/or optionally pre-cured, cured and optionally dried as outlined above in relation to the Hatschek process.

### BRIEF DESCRIPTION OF THE DRAWINGS

Certain embodiments of the present disclosure will now be described, by way of example only, with reference to the accompanying drawings. From figure to figure, the same or similar reference numerals are used to designate similar components of an illustrated embodiment.

FIG. 1 is a graph of the % linear expansion of fiber cement-gypsum exemplary formulations 1 to 4 of the present disclosure over time;

FIG. 2 is a graph of the % linear expansion of fiber cement-gypsum exemplary formulations 1 to 4 of the present disclosure over 328 days;

FIG. 3 is a graph of the % linear expansion of fiber cement-gypsum exemplary formulations 5 to 8 of the present disclosure over time;

FIG. 4 is a graph of the % linear expansion of fiber cement-gypsum exemplary formulations 5 to 8 of the present disclosure over 332 days;

FIG. 5 is a boxplot of moisture movement (MM) of fiber cement-gypsum exemplary formulations 1 to 4 when tested in accordance with ASTM C1185 (2016);

FIG. 6 is a boxplot of moisture movement (MM) of fiber cement-gypsum exemplary formulations 9 to 12 when tested in accordance with ASTM C1185 (2016); and

FIG. 7 is a graph of the time in mins for samples of fiber cement-gypsum exemplary formulations 1 to 8 to reach a temperature of 140° C.

### DETAILED DESCRIPTION

Although making and using various embodiments are discussed in detail below, it should be appreciated that the embodiments described provide inventive concepts that may be embodied in a variety of contexts. The embodiments discussed herein are merely illustrative of ways to make and use the disclosed devices, systems and methods and do not limit the scope of the disclosure.

In the description which follows like parts may be marked throughout the specification and drawing with the same reference numerals, respectively. The drawing figures are not necessarily to scale and certain features may be shown exaggerated in scale or in somewhat generalized or schematic form in the interest of clarity and conciseness.

The present technology provides fiber cement gypsum composite formulations that may have desirable attributes relative to conventional formulations. Specifically, certain embodiments of the present disclosure provide fiber cement gypsum composite formulations that include both the desirable fire and heat protection properties of gypsum articles and the desirable structural and water resistance properties of fiber cement formulations. The disclosed formulations may be formed into fiber cement gypsum articles in any suitable size and shape, such as for interior or exterior building articles. Accordingly, the advantageous formulations disclosed herein may allow for the manufacture of such water-resistant and heat-resistant building articles, while substantially mitigating the problems associated with delayed ettringite formulation that have occurred in previous attempts to develop such formulations.

Gypsum is formed by the rapid hydration of calcium sulfate dihydrate and is not water resistant. In contrast, hydraulic cements are formed by hydration of calcium silicate and aluminate materials in the cement composition. Hydraulic cements formed in this manner are usually water resistant. Hydration of cement takes places at a slower rate than that of hydration of gypsum.

It is often desired to improve the water resistance of gypsum articles by combining gypsum and cement together. One of the recognized difficulties when combining gypsum and cement together is that ettringites are formed when tricalcium aluminate (3CaO·Al₂O₃) in cement react with sulfate in gypsum as shown below:

3CaO·Al₂O₃+3(CaSO₄·2H₂O)+26H₂O→3CaO·Al₂O₃·3(CaSO₄)·32H₂O.

1 part of tricalcium aluminate reacts with 1.9 parts of the sulfate component in gypsum to yield 4.75 parts of ettringite. Generally, the volume expansion associated with early formed ettringite (e.g., ettringite formed within the first 24 hours of the reaction) does not lead to any deterioration in the final cement composite structure as the composite gypsum cement material is still soft within this time frame. Some of the early formed ettringite also decomposes to monosulfate hydrate (AFm: Aluminate Ferrite Monosulfate 3CaO(Al,Fe)₂O₃CaSO₄·nH₂O). However, there are a number of factors which may impact the decomposition process or result in reversal of the decomposition whereby AFm converts back to ettringite. This phenomenon is often referred to as delayed ettringite formation (DEF) and can result in damage to the cement composite structure if it occurs after the cement composite formulation has hardened which is usually outside the first 24 hours of the reaction. Ettringite thus formed in a cement composite structure is undesirable as it can lead to disruption via cracking due to non-uniform localized expansion in the area where the DEF ettringite forms. Consequently, there is inherent damage to the cement composite structure.

Generally, the conditions causing the appearance of DEF are as follows:
An excessive rise of temperature during early curing (>70° C.), related to the high heat of hydration or due to the steam curing of the gypsum-cement composition;
A moist environment; and/or
The presence of sulfates reacting with excess aluminates in the system.
   Traditionally, methods of preventing DEF have concentrated on controlling one or more of these conditions. The following disclosure provides one or more fiber cement gypsum composite formulations, each of which do not rely on any of these traditional methods to prevent the appearance of DEF.

In one embodiment, the formulations of the present disclosure provide fiber cement and gypsum composite that provide desired thermal and fire performance properties. Advantageously, the formulations of the present disclosure also prevent delayed ettringite formation and consequently prevent non-uniform localized expansion and cracking in the cured composite product.

The fiber cement gypsum composite formulations of the present disclosure comprise a binder, reinforcing fibers and a pozzolanic material.

In one embodiment, the binder comprises a gypsum-hydraulic cement mix, wherein gypsum is calcium sulfate dihydrate and the hydraulic cement is Portland cement. In one embodiment, the gypsum-cement mix comprises between approximately 50 to 75 wt % of the total wt % of the fiber cement gypsum composite formulation. In a further embodiment, the gypsum-cement mix comprises any sub-range between approximately 50 wt % and approximately 75 wt % of the total wt % of the fiber cement gypsum composite formulation. In a further embodiment, the gypsum component of the fiber cement gypsum composite formulation comprises between approximately 30 to 45 wt % of the total wt % of the fiber cement gypsum composite formulation or any suitable sub-range between approximately 30 to 45 wt % of the total wt % of the fiber cement gypsum composite formulation such that the gypsum-cement mix comprises between approximately 50 to 75 wt % or any suitable sub-range between approximately 50 wt % and approximately 75 wt % of the total wt % of the fiber cement gypsum composite formulation. In one particular embodiment, the gypsum component of the fiber cement gypsum composite formulation comprises 40 wt % of the total wt % of the fiber cement gypsum composite formulation. In a further particular embodiment, the gypsum component of the fiber cement gypsum composite formulation comprises 35 wt % of the total wt % of the fiber cement gypsum composite formulation. In a further embodiment the hydraulic cement component comprises approximately 20 to 30 wt % of the total wt % of the fiber cement gypsum composite formulation or any suitable sub-range between approximately 20 to 30 wt % of the total wt % of the fiber cement gypsum composite formulation such that the gypsum-cement mix comprises between approximately 50 to 75 wt % or any suitable sub-range between approximately 50 wt % and approximately 75 wt % of the total wt % of the fiber cement gypsum composite formulation. In all exemplary formulations the wt % quantity of gypsum component of the fiber cement gypsum composite formulation is the primary component whereby the wt % quantity of gypsum component within the fiber cement gypsum composite formulation dictates the wt % quantity of the hydraulic cement component such that the total wt % quantity of the gypsum-hydraulic cement mix in the fiber cement gypsum composite formulation comprises between approximately 50 to 75 wt % of the total wt % of the fiber cement gypsum composite formulation.

In one embodiment the ratio of gypsum to cement in the gypsum-cement mix ranges between approximately 1:1 and 1.6:1, more preferably between approximately 1:1, 1.1:1, 1.15:1, 1.16:1, 1.2:1, 1.3:1, 1.4:1, 1.5:1 and 1.6:1.

In one embodiment, the reinforcing fibers comprise cellulose fibers. In one embodiment, the cellulose fibers are sourced from kraft pulp, wherein the cellulose fibers have a length that is in the range of approximately 2 mm to 7 mm. In one embodiment, the cellulose fiber is bleached cellulose fiber, wherein the bleached fiber has a kappa number of between 0 and 5 by TAPPI method T236. In a further embodiment, the cellulose fiber is unbleached cellulose fiber, wherein the unbleached fiber has a kappa number of between 20 and 30 by TAPPI method T236, or between 22 and 28 by TAPPI method T236. In a further embodiment, the cellulose fiber is a combination of bleached and unbleached cellulose fiber, wherein the bleached fiber has a kappa number of between 0 and 5 by TAPPI method T236 and the unbleached fiber has a kappa number of between 20 and 30 by TAPPI method T236, or between 22 and 28 by TAPPI method T236. In one embodiment, the reinforcing fibers comprise between approximately 7 wt % and approximately 10 wt % of the total wt % fiber cement gypsum composite formulation. In a further embodiment, the suitable range of reinforcing fiber in the fiber cement material formulation is any sub-range between approximately 7 wt % and approximately 10 wt % of the total wt % fiber cement gypsum composite formulation.

In a further embodiment, the reinforcing fibers comprise a combination of cellulose fibers and synthetic fibers and/or mineral fibers. Combining cellulose fibers with synthetic fibers in fiber cement formulations is known to enhance the ductility of the fiber cement materials. In such embodiments, the cellulose fibers are sourced from kraft pulp as outlined above and the synthetic fibers comprise polypropylene (PP) fibers, whilst the mineral fibers include appropriate mineral fibers including for example basalt fibers. In such embodiments, some or all of the wt % of cellulose fibers in the wt % range of reinforcing fibers are replaced by either synthetic fibers or mineral fibers or a combination of synthetic fibers and mineral fibers. In some embodiments, the reinforcing fibers comprise between approximately 4 to 6 wt % of cellulose fibers of the total wt % fiber cement gypsum composite formulation and approximately 1 to 3 wt % synthetic fibers of the total wt % fiber cement gypsum composite formulation. In an alternative embodiment, the reinforcing fibers comprise between approximately 4 to 6 wt % of cellulose fibers of the total wt % fiber cement gypsum composite formulation and approximately 1 to 3 wt % mineral fibers of the total wt % fiber cement gypsum composite formulation. In a further embodiment, the reinforcing fibers comprise between approximately 4 to 6 wt % of cellulose fibers of the total wt % fiber cement gypsum composite formulation and approximately 1 to 3 wt % of a combination of synthetic and mineral fibers of the total wt % fiber cement gypsum composite formulation. In one particular exemplary embodiment, the reinforcing fibers comprise approximately 4 wt % of cellulose fibers and approximately 2 wt % synthetic fibers, wherein the synthetic fibers are polypropylene fibers.

In one embodiment, the pozzolanic material comprises either metakaolin or silica fume. In one embodiment, the pozzolanic material comprises between approximately 5 to 11 wt % of the total wt % of the fiber cement gypsum composite formulation. In one particular embodiment, the pozzolanic material comprises approximately 5 wt % of the total wt % of the fiber cement gypsum composite formulation. In a further embodiment, the pozzolanic material comprises approximately 7.5 wt % of the total wt % of the fiber cement gypsum composite formulation. In another particular embodiment, the pozzolanic material comprises approximately 10 wt % of the total wt % of the fiber cement gypsum composite formulation. Use of pozzolanic material in the fiber cement gypsum composite formulation was further found to reduce the effect of DEF which in turn reduces volume expansion and consequential shrinkage.

Referring now to Table One below, there is shown typical compositional wt % analysis of the pozzolanic materials which are suitable for use in the fiber-cement gypsum composite formulations of the present disclosure.

TABLE ONE

| Sample | | | | | | | | | | Sum of |
|---|---|---|---|---|---|---|---|---|---|---|
| Identification | SiO₂ % | Al₂O₃ % | Fe₂O₃ % | CaO % | MgO % | Na₂O % | K₂O % | SO₃ % | LOI % | Conc. % |
| Silica Fume | 91.42 | 0.24 | 1.05 | 0.57 | 2.80 | 0.13 | 0.55 | 0.04 | 2.90 | 100.00 |
| Metakaolin | 51.63 | 43.82 | 0.79 | 0.18 | 0.09 | 0.02 | 0.15 | 0.02 | 1.40 | 100.00 |

Without wishing to be bound by theory, it is considered that use of silica fume as a pozzolanic material leads to minimization of ettringite formation and maximizes calcium silicate hydrate (CSH) formation. In contrast, it is considered that metakaolin reacts quickly with aluminates present in the cement and prevents a reaction with gypsum to form expansive calcium sulfo-aluminates. Metakaolin has significantly more aluminum present in its composition relative to that of silica fume. Ettringite formation in the cementitious material is accelerated due to the high levels of aluminum present in metakaolin. Consequently, use of metakaolin as a pozzolanic material leads to early ettringite formation which occurs prior to hardening of the cementitious material and thus does not lead to any deterioration in the final cement composite structure. It is also considered that the addition of pozzolanic material in the fiber cement gypsum composite formulation can lead to bulking up of calcium silicate hydrate and engulfing of the gypsum particles thus providing moisture resistance to the gypsum particles within articles formed from the fiber cement-gypsum composite formulation.

In one embodiment the ratio of cement to pozzolanic material in the gypsum-cement mix ranges between approximately 1:0.1 and 1:0.5, more preferably between approximately 1:0.1, 1:0.15, 1:0.2, 1:0.25, 1:0.3, 1:0.35, 1:0.4, 1:0.45 and 1:0.5.

In one embodiment, the fiber cement gypsum composite formulations of the present disclosure further comprise a filler material. In some instances, the filler material is selected from either limestone or silica. Both filler materials are regarded as being inert filler materials. In the exemplary formulations of the present disclosure, the total wt % of the binder, reinforcing fibers and a pozzolanic material ranges between approximately 69 and 100 wt % of the total wt % of the formulation. Accordingly, the wt % of the filler component ranges between approximately 0 wt % and approximately 31 wt % to ensure that the total wt % of the formulation is always 100 wt %. In some embodiments, the filler material comprises approximately 5 to 31 wt % of the total wt % of the fiber cement gypsum composite formulation or any sub-range within approximately 5 to 31 wt % of the total wt % of the fiber cement gypsum composite formulation. In some embodiments, the filler material comprises approximately 18 wt % of the total wt % of the fiber cement gypsum composite formulation.

In a further embodiment, the formulations of the present disclosure further optionally comprise a low-density modifying agent, for example, expanded perlite. In one particular embodiment, the low-density modifying agent comprises approximately 5 wt % of the total wt % of the fiber cement gypsum composite formulation. In some embodiments, wherein a low-density modifying agent is present in the fiber cement gypsum composite formulation, the wt % range of the filler material is between 0 wt % and 26 wt % of the total wt % of the fiber cement gypsum composite formulation. In such embodiments, the oven dry density of the fiber cement gypsum composite formulation ranges between approximately 1.15 g/cm³ and 1.25 g/cm³. Advantageously, use of a low-density modifying agent in the fiber cement gypsum composite formulation provides a lightweight fiber cement gypsum composite formulation that is similar or equivalent to a corresponding fiber cement low density material.

In one embodiment of the present disclosure the fiber cement gypsum composite formulation is air cured wherein curing occurs at ambient temperature which is defined as being approximately 23° C. or 73.4° F. In a further embodiment the fiber cement gypsum composite formulation is air cured wherein curing occurs at any temperature between ambient temperature and approximately 82° C. or 180° F. In such embodiments, the humidity of the environment is monitored to ensure that sufficient moisture is present in the atmosphere to prevent dehydration of gypsum. The maximum moisture content in the air varies in accordance with temperature, and it is preferable for the humidity of the air to be between 80% and 100% relative humidity during curing at elevated temperatures. It is suggested that curing the fiber cement gypsum composite formulation in this way helps accelerate the strength gained by the composite material formed by controlling ettringite formation, preserving gypsum and hydrated CSA phases in the cement reactions.

Exemplary formulations of the present disclosure will now be described.

Referring initially to Table Two, there are shown five examples of a fiber cement gypsum composite formulation. Exemplary samples were made of each fiber cement gypsum composite formulation by mixing the raw materials of each respective formulation in a Hobart mixer for 10 minutes with water to form a slurry. The ratio of dry material to water was approximately 1:2.5. After mixing, the slurry was transferred to a pad press. The slurry mixture was subjected to a pressing pressure of approximately 30 tons for a holding time of 1 minute thereby reducing the moisture content in the slurry. The exemplary sample was cured in 90% relative humidity (HR) for 4 days. Once cured for 4 days, each exemplary sample was cut to the appropriate size to enable testing to take place. In one example, the sample was cut to approximately 250 mm×25 mm. After cutting the samples were further cured for an additional 7 days under water in a hot water bath at 60° C. or 140° F.

TABLE TWO

| | Exam- | Exam- | Exam- | Exam- | Exam- |
|---|---|---|---|---|---|
| | ple 1 | ple 2 | ple 3 | ple 4 | ple 4A |
| | % wt | % wt | % wt | % wt | % wt |
| Fibers | 10 | 10 | 10 | 10 | 10 |
| Cement | 30 | 30 | 30 | 30 | 25 |
| Gypsum | 30 | 40 | 30 | 40 | 40 |
| Metakaolin | 10 | 10 | | | |
| Silica Fume | | | 10 | 10 | 5 |
| Limestone | 20 | 10 | 20 | 10 | |
| Silica | | | | | 20 |
| Total | 100 | 100 | 100 | 100 | 100 |

Referring initially to Table Three there are shown four further examples of a fiber cement gypsum composite formulation which includes a low-density additive. As before, exemplary samples were made of the fiber cement gypsum composite formulation by mixing the raw materials of each respective formulation in a Hobart mixer for 10 minutes with water to form a slurry. The ratio of dry material to water was approximately 2.5. After mixing the slurry was transferred to a pad press to form each exemplary sample. The slurry mixture was subjected to a pressing pressure of approximately 25 tons for a holding time of 1 min thereby reducing the moisture content in the slurry. The exemplary sample was cured in 90% HR for 4 days. Once cured for 4 days, each exemplary sample was cut to the appropriate size to enable testing to take place. In one example, the sample was cut to approximately 250 mm×25 mm. After cutting the samples were further cured for an additional 7 days under water in a hot water bath at 60° C. or 140° F.

TABLE THREE

| | Example 5 | Example 6 | Example 7 | Example 8 |
|---|---|---|---|---|
| | % wt | % wt | % wt | % wt |
| Fibers | 10 | 10 | 10 | 10 |
| Cement | 30 | 30 | 30 | 30 |
| Gypsum | 30 | 40 | 30 | 40 |
| MetaKaolin | 10 | 10 | | |
| Silica Fume | | | 10 | 10 |
| Expanded Perlite | 5 | 5 | 5 | 5 |
| Limestone | 15 | 5 | 15 | 5 |
| Total | 100 | 100 | 100 | 100 |

Turning now to Table Four, there are shown five further examples of a fiber cement gypsum composite formulation. The examples of Table 4 are similar to those of Table 3; however, the % wt of the reinforcing fibers has been reduced from 10 wt % to 7 wt %.

TABLE FOUR

| | Example 9 | Example 10 | Example 11 | Example 12 | Example 13 | Example 13(a) |
|---|---|---|---|---|---|---|
| | % wt | % wt | % wt | % wt | % wt | % wt |
| Fibers | 7 | 7 | 7 | 7 | 7 | 7 |
| Cement | 25 | 25 | 25 | 25 | 30 | 30 |
| Gypsum | 30 | 35 | 40 | 35 | 35 | 35 |
| MetaKaolin | | | | 10 | | |
| Silica Fume | 7.5 | 7.5 | 7.5 | | 5 | 5 |
| Silica | 25.5 | 20.5 | 15.5 | 18 | 18 | 23 |
| Expanded | 5 | 5 | 5 | 5 | 5 | |
| Perlite | | | | | | |
| Total | 100 | 100 | 100 | 100 | 100 | 100 |

Method of Manufacture

In the embodiment detailed in the present disclosure, fiber cement gypsum composite building articles, such as for example, fiber cement gypsum composite building panels are made from the fiber cement gypsum composite formulations herein disclosed using the Hatschek process. In the Hatschek process, a fiber cement gypsum slurry is formed, which comprises at least a binder, a pozzolanic material and reinforcing fibers. The slurry optionally further comprises one or more of the additional formulation components as set out in the present disclosure. The slurry is deposited on a plurality of sieve cylinders that are rotated through the fiber cement gypsum slurry such that the fibers filter the fiber cement gypsum slurry to form a thin fiber cement gypsum film on a belt passing in contact with the sieve cylinders. A region of the belt containing a layer of fiber cement gypsum film may be passed over the sieve cylinders again to form an additional layer of fiber cement gypsum film against the first layer, and the process may be repeated until enough layers of fiber cement gypsum film are present to form a building article having a desired thickness. For example, in some embodiments the building article may be formed with two, three, four, five, or more layers.

The fiber cement gypsum composite building article is optionally pressed during the manufacturing process before curing whilst in a green sheet state at a pressure range of between approximately 15 MPa and approximately 25 MPa for a period of between approximately 5 mins and approximately 10 mins.

The green sheet fiber cement gypsum composite article is cured at a temperature of between approximately 60° C. and approximately 80° C., whilst at between approximately 90% and 100% relative humidity for a period of between approximately 18 and approximately 24 hours after the fiber cement gypsum composite article has been manufactured using the Hatschek Process. Optionally in one embodiment of the present disclosure the green sheet fiber cement gypsum composite article is pre-cured at ambient temperature for a period of approximately 6 and approximately 12 hours before the step of being cured at a temperature of between approximately 60° C. and approximately 80° C., whilst at between approximately 90% and 100% relative humidity for a period of between approximately 18 and approximately 24 hours.

The cured fiber cement gypsum composite article is optionally dried for a period of between approximately 30 and approximately 60 minutes at a temperature of between approximately 60° C. and approximately 80° C., whilst at less than approximately 10% relative humidity.

It is also possible that alternative suitable fiber cement manufacturing processes, such as, for example, Flow-on or Fourdrinier or any other suitable manufacturing process known to the skilled person could also be used.

A series of tests were carried out on articles formed from the exemplary formulations of the present disclosure to determine various physical properties of the fiber cement gypsum composite articles of the exemplary formulations. Delayed ettringite formation was measured using an expansion test as outlined below.

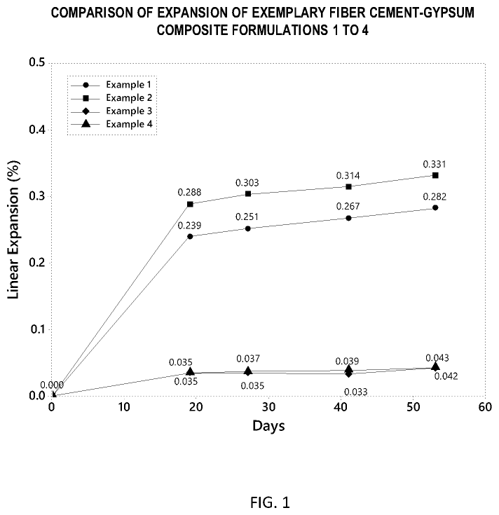

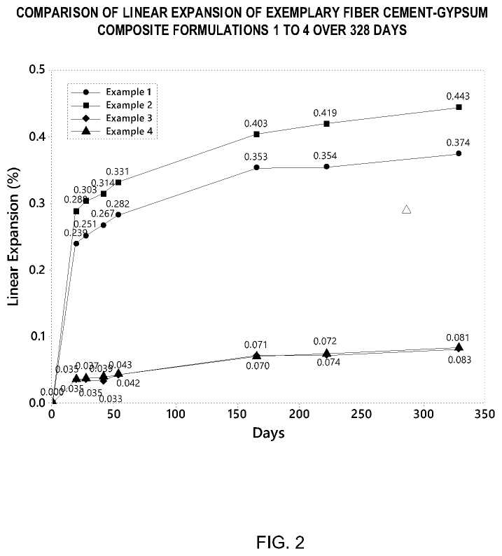

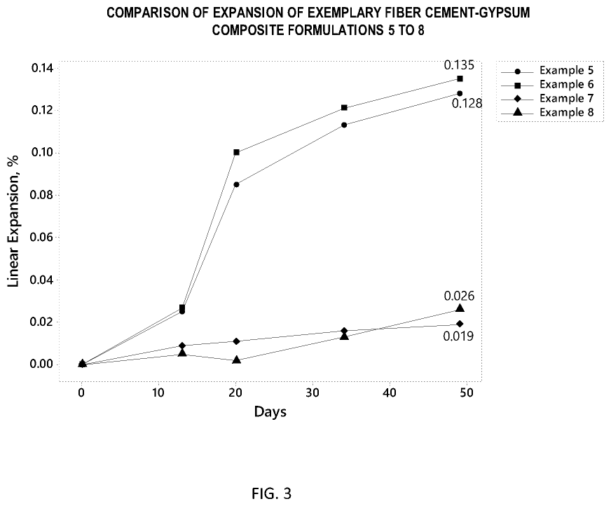

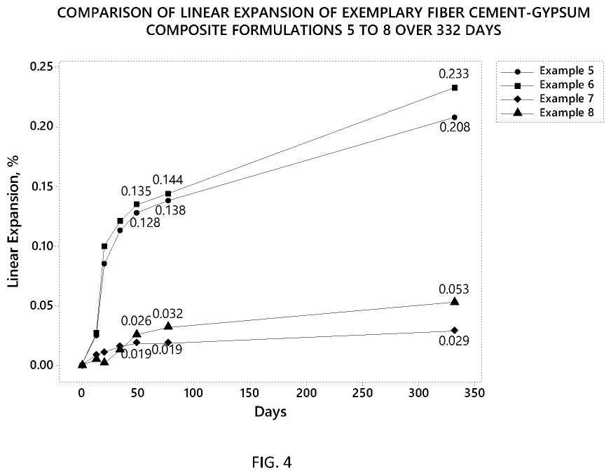

Expansion Test: Samples of each exemplary formulation 1 to 8 were formed as outlined above. The length of each sample was measured when cut after the initial 4 days curing. This length is classified as the initial length of each sample. The length of the cut samples were then continuously monitored for a period of 60 days to determine expansion of the sample due to delayed ettringite formation (DEF) and were measured at pre-determined intervals during the 60 day period and also during an extended 328 day/328 day period for examples 1 to 4 and 5 to 8 respectively. The samples were submerged in water during the expansion test. The percentage expansion of each sample was calculated relative to the initial length and is presented below in Table Five. The percentage expansion of each sample over the 60 day period is shown graphically in FIGS. 1 and 3 and the extended 328/332 day periods are shown in FIG. 2 and FIG. 4 respectively.

TABLE FIVE
Expansion Table for Examples 1 to 4

Linear Expansion (%)

| Days | Example 1 | Example 2 | Example 3 | Example 4 |
|---|---|---|---|---|
| 0 | 0 | 0 | 0 | 0 |
| 19 | 0.239 | 0.288 | 0.035 | 0.035 |
| 27 | 0.251 | 0.303 | 0.035 | 0.037 |
| 41 | 0.267 | 0.314 | 0.033 | 0.039 |
| 53 | 0.282 | 0.331 | 0.042 | 0.043 |
| 165 | 0.353 | 0.403 | 0.071 | 0.07 |
| 221 | 0.354 | 0.419 | 0.072 | 0.074 |
| 328 | 0.374 | 0.443 | 0.081 | 0.083 |

Expansion Table for Examples 5 to 8

Linear Expansion (%)

| Days | Example 5 | Example 6 | Example 7 | Example 8 |
|---|---|---|---|---|
| 0 | 0 | 0 | 0 | 0 |
| 13 | 0.025 | 0.027 | 0.009 | 0.005 |
| 20 | 0.085 | 0.1 | 0.011 | 0.002 |
| 34 | 0.113 | 0.121 | 0.016 | 0.013 |
| 49 | 0.128 | 0.135 | 0.019 | 0.026 |
| 77 | 0.138 | 0.144 | 0.019 | 0.032 |
| 332 | 0.208 | 0.233 | 0.029 | 0.053 |

Each of the exemplary formulations exhibit minimal expansion over the testing period, indicating that there is little to no delayed ettringite formed using the exemplary formulations of the present disclosure. Turning specifically to FIGS. 1 and 3, in the exemplary samples in which silica fume comprises the pozzolanic material in the formulation, namely Examples 3, 4, 7 and 8, the % expansion of the sample material was determined to be less than 0.1%. Whilst in the exemplary formulations in which metakaolin comprises the pozzolanic material in the formulation, namely Examples 1, 2, 5 and 6, show slightly greater expansion than Examples 3, 4, 7 and 8. Nonetheless, the % linear expansion of the exemplary formulations including metakaolin is still desirably below 0.4%. In all examples, the % linear expansion of the fiber cement-gypsum formulation is significantly less that the acceptable upper limit of expansion of cementitious materials in the industry, which is approximately 1%. Accordingly, the % linear expansion of the exemplary formulations of the present disclosure are deemed to be minor. It can also be concluded that the presence of the low-density additive in Examples 5 to 8 had little impact on expansion.

Turning briefly to FIGS. 2 and 4, there is shown the average % linear expansion of further exemplary samples of Examples 1 to 4 and 5 to 8 over 328 and 332 days respectively. As before the length of the cut samples were continuously monitored to determine expansion of the sample due to DEF and were measured at pre-determined intervals during the 328/332 day period. Again, the samples were submerged in water during the test. The samples also continue to show minimal expansion over the extended period of the text. It was concluded therefore that incorporation of the pozzolanic materials of the present disclosure in the fiber cement gypsum composite formulation inhibited DEF.

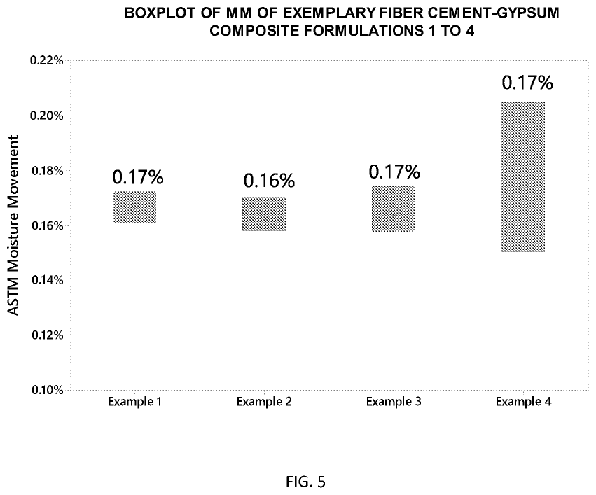

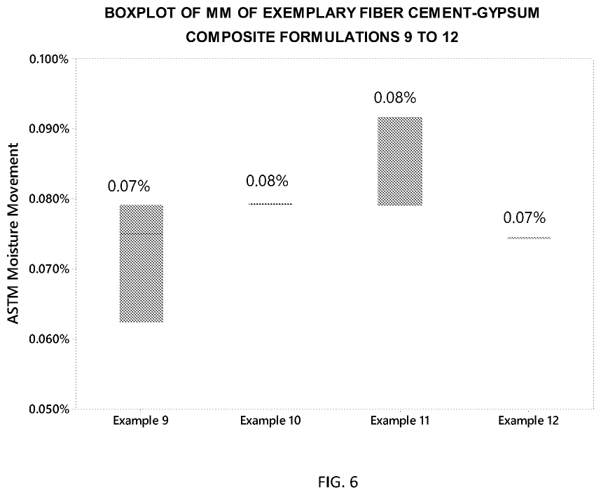

Moisture durability of the exemplary formulations of the present disclosure were also measured in order to ensure that the articles formed using the fiber cement-gypsum composite formulations were both dimensionally stable and durable relative to typical fiber cement products. The moisture movement (MM) of samples comprising the exemplary formulations of examples 1 to 4 of Table 2 and examples 9 to 12 of Table 4 were tested in accordance with ASTM C1185 (2016). The results are presented in the boxplots of FIGS. 5 and 6. When tested, the average moisture movement of examples 1 to 4 were determined to be on average approximately 0.16% and 0.17% respectively, whilst the moisture movement of examples 9 to 12 were on average between approximately 0.07-0.08%. The moisture movement of examples 1 to 4 were deemed to be on par with a typical moisture movement value of an equivalent air cured fiber cement product which is on average approximately 0.13%. In contrast, moisture movement of Examples 9 to 12 is significantly less than a typical moisture movement value of an equivalent air cured fiber cement product. This was deemed acceptable; thus, it was determined that the reduction of reinforcing fibers in the fiber cement-gypsum composite formulation has little impact on the overall moisture durability of the composite material. Experimental MM values corresponding to the boxplots of FIGS. 5 and 6 are provided in Table Six below. Although not represented in the Boxplots of FIGS. 5 and 6, Example 13 returned an average MM value of 0.09%.

TABLE SIX

| Formulation | ASTM MM |
|---|---|
| Example 1 | 0.17% |
| | 0.16% |
| | 0.17% |
| Example 2 | 0.16% |
| | 0.16% |
| | 0.17% |
| Example 3 | 0.16% |
| | 0.16% |
| | 0.17% |
| Example 4 | 0.21% |
| | 0.15% |
| | 0.17% |
| Example 9 | 0.075% |
| | 0.062% |
| | 0.079% |
| Example 10 | 0.079% |
| | 0.079% |
| | 0.079% |
| Example 11 | 0.079% |
| | 0.092% |
| | 0.083% |
| Example 12 | 0.074% |
| | 0.074% |
| | 0.075% |

In industry, coefficient softening (CS) ratios are generally used to define a material's water resistance level. A material CS ratio is defined as R2/R1, where R1 is the average absolute dry strength value of the dry specimens (MPa) and R2 is the average breaking load value of the water saturated specimens (MPa). Gypsum binders depending on the value of the coefficient softening CS ratio, are divided into the following categories:
non-waterproof—CS<0.45
average water resistance—0.45<CS<0.6;
increased water resistance—0.6<CS<0.8;
water resistant—CS>0.8

In the present disclosure it was desired for the exemplary formulations to achieve an average coefficient softening CS ratio of 0.6 or above. Referring now to Table Seven, there is shown a comparison of the CS ratio between a typical exemplary fiber gypsum board (Certainteed TYPE X Fire Resistant Gypsum Board), an exemplary fiber cement board (JH Fiber Cement Backer Board), and exemplary samples comprising the fiber gypsum composite formulations outlined above.

TABLE SEVEN

| | Exemplary Fiber | Exemplary Fiber | Fiber cement-gypsum |
|---|---|---|---|
| | Gypsum Board | Cement Board | composite formulation |
| CS Ratio | 0.15 | >0.6 | 0.63 |

The exemplary fiber gypsum board has an average CS ratio of 0.15. In contrast, the exemplary fiber cement board has a CS ratio of greater than 0.6. The exemplary samples of the fiber gypsum composite formulations have an average CS ratio of 0.63. This indicates that the fiber gypsum composite formulation samples have increased water resistance ˜320% improvement over typical exemplary fiber gypsum boards.

The exemplary fiber gypsum composite articles of the present disclosure were also tested to determine the average Modulus of Rupture (MoR) in accordance with ASTM C 1185. Exemplary samples 9 to 13 were prepared as outlined above and conditioned to a saturated moisture condition by soaking in water at ambient temperature until reaching a constant mass over a 24-hour period. The samples were then subjected to a three-point flexure bend under a load until failure. Table Eight provides details of the load on the sample at failure. The results indicate that the exemplary fiber cement gypsum composite articles fall within the range of MoR's required for standard fiber cement building products i.e. between 4.5 to 7 MPa, whereby interior fiber cement building products require a lower MoR than corresponding exterior fiber cement building products.

TABLE EIGHT

| | Exam- | Exam- | Exam- | Exam- | Exam- |
|---|---|---|---|---|---|
| | ple 9 | ple 10 | ple 11 | ple 12 | ple 13 |
| Modulus of Rupture | 7.5 | 6.3 | 5.7 | 7.5 | 6.0 |
| (MPa) | | | | | |

It is generally understood that gypsum boards are known to have extremely good fire resistance. In contrast, it is known that fiber cement products to not achieve the same level of fire resistance as gypsum boards. It was desired for the articles formed from the exemplary fiber cement-gypsum composite formulations to achieve the equivalent or better fire rating than gypsum boards whilst also exhibiting the structural strength of fiber cement boards and moisture resistance of fiber cement boards. Accordingly, tests were also carried out on samples of the exemplary formulations 1 to 8 to determine the fire performance of the exemplary fiber cement gypsum composite formulations. In each case, it was desirable for the fiber cement-gypsum composite formulations to exhibit a better or parity fire performance as a typical commercially available gypsum board, exemplified by Certainteed TYPE X Fire Resistant Gypsum Board. It is generally understood that Certainteed TYPE X Fire Resistant Gypsum Board or Dry Wall is known to have a fire certification for 60 mins.

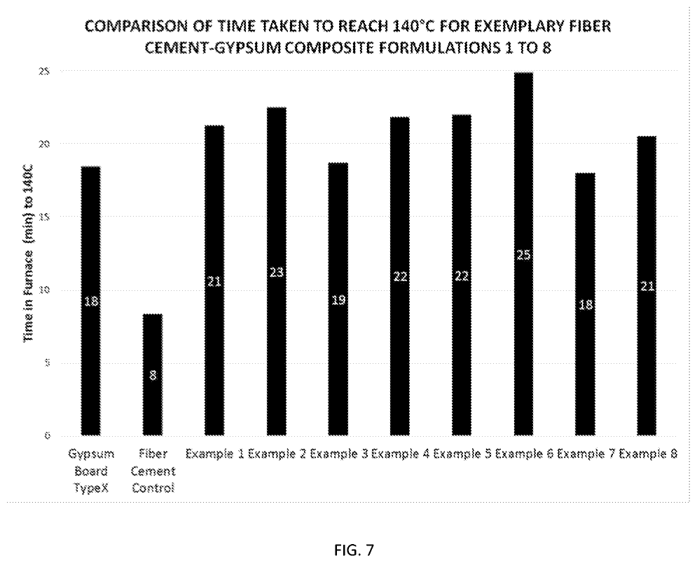

In the tests, samples of the exemplary formulations 1 to 8 as outlined above in Tables Two and Three were tested together with Certainteed TYPE X Fire Resistant Gypsum Board and an exemplary fiber cement board as control. Each of the samples were normalized to a thickness of approximately 16 mm. Thermostats were mounted to one side of the sample thickness. The other opposing side of the sample thickness were exposed to a constant heat in a lab furnace which was brought to a maximum temperature of 850° C., in excess of 140° C. The thermostats mounted to the samples were monitored to determine how long (minutes) it took for each of the thermostats to record a temperature of 140° C. on the opposite side of the sample thickness to the side exposed to the heat. The results are presented in FIG. 7. In each case the exemplary embodiments showed the same or improved thermal resistance to the commercially available Certainteed TYPE X Fire Resistant Gypsum Board. Further tests were carried out on samples of exemplary formulations 9 to 13 below

TABLE NINE

| | Exam- | Exam- | Exam- | Exam- | Exam- |
|---|---|---|---|---|---|
| | ple 9 | ple 10 | ple 11 | ple 12 | ple 13 |
| Time to raise +140 C., | 14.4 | 16.5 | 18.4 | 17.6 | 16.6 |
| adjusted to thickness of | | | | | |
| 15.9 mm, min | | | | | |

The commercial fire resistance gypsum board (Certainteed TYPE X Fire Resistant Gypsum Board) comprises gypsum (CaSO₄·2H₂O) wherein the board contains approximately 80% gypsum and approximately 20% chemical bonded water. The chemical bonded water slows down the rate at which the temperature rises in a fire situation due to chemical de-bonding of water during fire. In contrast, the fiber cement gypsum composite materials formed using the exemplary formulations outlined above achieve fire performance with lower gypsum levels (30-45 wt %). The samples of the exemplary fiber cement gypsum composite formulations exhibited equivalent or better fire performance than that of typical commercial fiber gypsum board. Without wishing to be bound by theory it is believed that the fiber cement-gypsum composite formulations achieve fire performance because hydraulic cement coats the gypsum in the formulation to improve water resistance and tricalcium aluminate (C₃A) from cement reacts with gypsum to form amorphous ettringite (C₆AS₃H₃₂) that contains 46% chemical bonded water and provides greater fire resistance than typically available commercial gypsum board as exemplified by TYPEX.

Intumescent coatings are materials that when applied onto substrates improve the fire performance of the substrate by creating an insulative char layers when heated above about 300 C. The insulative char layer slows the rate of heat transfer from one side to the other and prolongs the time as measured by ASTM E119 test method. The manufacturers of intumescent coatings recommend particular application rates to achieve 1 hour fire rating. For example, in the case of the intumescent coatings of the present invention, Contego International, the manufacturer of the specific intumescent coating used to demonstrate this invention recommends that for dry wall a wet coating thickness of 535 microns (0.454 grams/sqin) equivalent to 380 microns DFT to add one hour of fire performance.

In a further embodiment of the present disclosure, further samples of building articles comprising one or more of the exemplary formulations were tested in a wall assembly configuration as outlined below.

Wall assembly configuration with intumescent coating:

Small scale wall assemblies were prepared and tested using a lab-scale kiln as the heat source to simulate a fire event that occurs on one side of such assembly. The assembly comprises a wood frame made with 2″×4″ wooden framing members. The fiber gypsum composite articles were nailed to each side of the frame. The assembly also contained a standard 3″ fiber glass insulation inside the assembly. The assembly was placed in a furnace such that one side of the assembly was adjacent to the heat source (so-called hot side) and the opposite side was remote from the heat source (so-called cold side). To start the test, the furnace was heated to about 1000 C. The furnace was then cooled to about 600 C. The assembly would then be placed on the furnace as previously described and the test would commence.

In the study, exemplary fiber gypsum composite articles comprising example 13 formulation were pre-dried for 24 hours in 50° C. Uncoated dried fiber gypsum composite articles were tested together with dried fiber gypsum composite articles which were coated with an intumescent paint (Contego) at different coating levels. The intumescent coating was applied by brushing in a standard paint application manner using a foam brush. Thermocouples were placed at three locations on the assembly to measure and record the temperature during the furnace testing: A first thermocouple was placed on the inner surface of the side nearest the furnace (so called the hot side), a second thermocouple was placed on the inner surface of the side furthest from the furnace (cold side) and a third thermocouple was placed on the outer surface of the cold side of the assembly.

The time it took for the third thermocouple to reach 140° C. was measured to determine the performance of the exemplary fiber gypsum composite articles under these conditions. The performance data is presented below in Table 10.

TABLE TEN

| | Intumescent | Assembly | | |
|---|---|---|---|---|
| Sample | Coating + wet | Dimension | | Time to +140 C., |
| Number | weight g/in² | in | Insulation | min. |
| 1 | 0 | 12 × 14 | Glass fiber | 66.4 |
| 2 | 0 | 14 × 14 | Glass fiber | 73.2 |
| 3 | Contego 0.38 | 12 × 14 | Glass fiber | 82.8 |
| 4 | Contego 0.39 | 14 × 14 | Glass fiber | 106 |
| 5 | Contego 0.25 | 14 × 14 | Glass fiber | 99.9 |
| 6 | Contego 0.10 | 14 × 14 | Glass fiber | 85.1 |
| 7 | Contego 0.39 | 14 × 14 | None | 49.8 |
| 8 | 0 | 14 × 14 | Glass fiber | 88.8 |

The data in Table Ten indicates that the application of the Contego intumescent coating contributes positively to the fire performance of the assembly as measured by the time to +140 C. Additionally, it was seen that the coating level as measured by wet weight applied also correlated with fire performance.

The protection afforded to the board by coating the backside with intumescent paint was evaluated by measuring the residual amount of hydrated gypsum remaining in the board at the completion of the furnace testing. Table 11 shows the results of QXRD analysis of samples taken from the hot and cold sides of assemblies after completion of the furnace testing. The results indicate that the Contego intumescent coatings helped retain more of the gypsum for both the hot and cold sides of the assembly. The Contego intumescent coatings also helped reduce the amount of dehydration that occurred on both the hot and cold sides to create hemihydrate and anhydrite of gypsum. Overall the degree of dehydration of the gypsum component of the Zeus boards was calculated and shown in Table 12 indicating significant reduction in this value when intumescent coating was applied to one surface of the Zeus boards.

TABLE 11
QXRD results of the Zeus assemblies post furnace testing

| | Hot Side - | Hot Side - | Cold Side - | Cold Side - |
|---|---|---|---|---|
| | No | with | No | with |
| | Contego | Contego | Contego | Contego |
| Gypsum | 1.6 | 2.5 | 1.8 | 14.3 |
| Hemihydrate | 0 | 6.4 | 19 | 8.3 |
| Anhydrite | 17.7 | 10.6 | 0.3 | 0.2 |
| Ettringite | 1.9 | 0.1 | 0.8 | 1.2 |
| Calcite | 3.1 | 4.8 | 6.0 | 2.5 |
| C2S | 6.8 | 6.4 | 0 | 0 |
| C3S | 1 | 1 | 0.8 | 0.7 |
| C4AF | 0.1 | 0 | 0.1 | 0 |
| Quartz | 19.3 | 18.5 | 16.9 | 16.8 |
| Amorphous | 48.5 | 49.7 | 54.3 | 56.0 |
| Total | 100.0 | 100.0 | 100.0 | 100.0 |

TABLE 12
Degree of dehydration of Gypsum component
of Zeus boards in test assemblies

| | Hot Side - | Hot Side - | Cold Side - | Cold Side - |
|---|---|---|---|---|
| | No | with | No | with |
| | Contego | Contego | Contego | Contego |
| Degree of | 93.3% | 81.0% | 70.0% | 31.0% |
| Dehydration | | | | |
| of Gypsum | | | | |

### ADDITIONAL EMBODIMENTS

Embodiment 1 may comprise a fiber cement gypsum composite formulation comprising a binder, reinforcing fibers, and a pozzolanic material, wherein the binder comprises a gypsum-cement mix comprising gypsum and a hydraulic cement, wherein the gypsum comprises calcium sulfate dihydrate, and wherein the hydraulic cement comprises Portland cement.

Embodiment 2 may comprise the fiber cement gypsum composite formulation of embodiment 1, wherein the gypsum-cement mix comprises between approximately 50 to 75 wt % of a total wt % of the fiber cement gypsum composite formulation.

Embodiment 4 may comprise the fiber cement gypsum composite formulation of embodiment 1 or embodiment 2, wherein the gypsum-cement mix comprises any sub-range between approximately 50 wt % and approximately 75 wt % of a total wt % of the fiber cement gypsum composite formulation.

Embodiment 4 may comprise the fiber cement gypsum composite formulation of any one of the previous embodiments, wherein gypsum comprises between approximately 30 to 45 wt % of a total wt % of the fiber cement gypsum composite formulation such that the gypsum-cement mix comprises between approximately 50 to 75 wt % of a total wt % of the fiber cement gypsum composite formulation.

Embodiment 5 may comprise the fiber cement gypsum composite formulation of any one of the previous embodiments, wherein gypsum comprises any sub-range between approximately 30 to 45 wt % of a total wt % of the fiber cement gypsum composite formulation such that the gypsum-cement mix comprises any suitable sub-range between approximately 50 to 75 wt % of a total wt % of the fiber cement gypsum composite formulation.

Embodiment 6 may comprise the fiber cement gypsum composite formulation of any one of the previous embodiments, wherein the gypsum comprises 40 wt % of a total wt % of the fiber cement gypsum composite formulation.

Embodiment 7 may comprise the fiber cement gypsum composite formulation of any one of the previous embodiments, wherein the gypsum comprises 35 wt % of a total wt % of the fiber cement gypsum composite formulation.

Embodiment 8 may comprise the fiber cement gypsum composite formulation of any one of the previous embodiments, wherein hydraulic cement comprises approximately 20 to 30 wt % of a total wt % of the fiber cement gypsum composite formulation such that the gypsum-cement mix comprises between approximately 50 to 75 wt % of a total wt % of the fiber cement gypsum composite formulation.

Embodiment 9 may comprise the fiber cement gypsum composite formulation of any one of the previous embodiments, wherein hydraulic cement comprises any sub-range between approximately 20 to 30 wt % of a total wt % of the fiber cement gypsum composite formulation such that the gypsum-cement mix comprises any sub-range between approximately 50 to 75 wt % of a total wt % of the fiber cement gypsum composite formulation.

Embodiment 10 may comprise the fiber cement gypsum composite formulation of any one of the previous embodiments, wherein a wt % ratio of gypsum to hydraulic cement in the gypsum-cement mix ranges between approximately 1:1 and 2:1, more preferably between approximately 1:1, 1.1:1, 1.15:1, 1.16:1, 1.2:1, 1.3:1, 1.4:1, 1.5:1, 1.6:1, 1.7:1, 1.8:1, 1.9:1 and 2:1.

Embodiment 11 may comprise the fiber cement gypsum composite formulation of any one of the previous embodiments, wherein the reinforcing fibers comprise cellulose fibers.

Embodiment 12 may comprise the fiber cement gypsum composite formulation of any one of the previous embodiments, wherein the reinforcing fibers comprise between approximately 7 to 10 wt % of a total wt % of the fiber cement gypsum composite formulation.

Embodiment 13 may comprise the fiber cement gypsum composite formulation of any one of the previous embodiments, wherein the reinforcing fibers further comprises synthetic fibers.

Embodiment 14 may comprise the fiber cement gypsum composite formulation of embodiment 13, wherein the synthetic fibers are polypropylene fibers.

Embodiment 15 may comprise the fiber cement gypsum composite formulation of any one of the previous embodiments, wherein the reinforcing fibers further comprise mineral fibers.

Embodiment 16 may comprise the fiber cement gypsum composite formulation of embodiment 15, wherein the mineral fibers are basalt fibers.

Embodiment 17 may comprise the fiber cement gypsum composite formulation of any one of embodiments 1 to 10, wherein the reinforcing fibers comprise approximately 4 wt % of cellulose fibers and approximately 2 wt % synthetic fibers, wherein the synthetic fibers are polypropylene fibers.

Embodiment 18 may comprise the fiber cement gypsum composite formulation of any one of the previous embodiments, wherein the pozzolanic material comprises metakaolin or silica fume.

Embodiment 19 may comprise the fiber cement gypsum composite formulation of any one of the previous embodiments, wherein the pozzolanic material comprises between approximately 5 to 11 wt % of a total wt % of the fiber cement gypsum composite formulation.

Embodiment 20 may comprise the fiber cement gypsum composite formulation of any one of the previous embodiments, wherein the pozzolanic material comprises approximately 5 wt % of a total wt % of the fiber cement gypsum composite formulation.

Embodiment 21 may comprise the fiber cement gypsum composite formulation of any one of the previous embodiments, wherein the pozzolanic material comprises approximately 7.5 wt % of a total wt % of the fiber cement gypsum composite formulation.

Embodiment 22 may comprise the fiber cement gypsum composite formulation of any one of the previous embodiments, wherein the pozzolanic material comprises approximately 10 wt % of a total wt % of the fiber cement gypsum composite formulation.

Embodiment 23 may comprise the fiber cement gypsum composite formulation of any one of the previous embodiments further comprising a filler material.

Embodiment 24 may comprise the fiber cement gypsum composite formulation of embodiment 23, wherein the filler material comprises limestone or silica.

Embodiment 25 may comprise the fiber cement gypsum composite formulation embodiment 23 or embodiment 24, wherein the filler material comprises between approximately 0 to 31 wt % of a total wt % of the fiber cement gypsum composite formulation.

Embodiment 26 may comprise the fiber cement gypsum composite formulation of any one of the previous embodiments further comprising a low-density modifying agent.

Embodiment 27 may comprise the fiber cement gypsum composite formulation of embodiment 26, wherein the low-density modifying agent comprises expanded perlite.

Embodiment 28 may comprise the fiber cement gypsum composite formulation of embodiment 26 or embodiment 27, wherein the low-density modifying agent comprises approximately 5 wt % of a total wt % of the fiber cement gypsum composite formulation.

Embodiment 29 may comprise the fiber cement gypsum composite formulation of any one of embodiment 26 to embodiment 28, wherein the low-density modifying agent further comprises approximately 13 to 28 wt % silica relative to a total wt % of the fiber cement gypsum composite formulation.

Embodiment 30 may comprise the fiber cement gypsum composite formulation of any one of embodiment 26 to embodiment 29, wherein the low-density modifying agent further comprises approximately 18 wt % silica relative to a total wt % of the fiber cement gypsum composite formulation.

Embodiment 31 may comprise the fiber cement gypsum composite formulation of any one of embodiment 26 to embodiment 30, wherein an oven dry density of the fiber cement gypsum composite formulation is approximately 1.1 g/cm³.

Embodiment 32 may comprise a fiber cement gypsum article comprising any one of the fiber cement gypsum composite formulations of embodiments 1 to 31.

Embodiment 33 may comprise the fiber cement gypsum article of embodiment 32, wherein the fiber cement gypsum article is a building panel.

Embodiment 34 may comprise the fiber cement gypsum article of embodiment 32 or embodiment 33, wherein the fiber cement gypsum article further comprises an intumescent coating material.

Embodiment 35 may comprise the fiber cement gypsum article of any one of embodiment 32 to embodiment 34, wherein the fiber cement gypsum article comprises a smooth or a textured surface.

Embodiment 36 may comprise the fiber cement gypsum article of any one of embodiment 32 to embodiment 35, wherein the fiber cement gypsum article comprises an aesthetic finish on at least a section of at least one major face of the fiber cement gypsum article.

Embodiment 37 may comprise the fiber cement gypsum article of embodiment 36, wherein the aesthetic finish comprises one or more of the group comprising textures, patterns, profiles, visual indicia and/or a decorative finish in the form of an applied coating material including for example, sealer, primer, paint or a digital print.

Embodiment 38 may comprise the fiber cement gypsum article of any one of embodiment 36 or embodiment 37, wherein the aesthetic finish is applied to at least one surface of the fiber cement gypsum article.

Embodiment 39 may comprise the fiber cement gypsum article of any one of embodiment 36 or embodiment 37, wherein the aesthetic finish is printed onto at least one surface of the fiber cement gypsum article.

Embodiment 40 may comprise the fiber cement gypsum article of any one of embodiment 36 or embodiment 37, wherein the aesthetic finish is embossed into at least one surface of the fiber cement gypsum article.

Embodiment 41 may comprise the fiber cement gypsum article of any one of embodiment 36 or embodiment 37, wherein the aesthetic finish is integrally formed in at least one surface of the fiber cement gypsum article.

Embodiment 42 may comprise the fiber cement gypsum article of any one of embodiment 36 or embodiment 37, wherein the aesthetic finish is machined into at least one surface of the fiber cement gypsum article.

Embodiment 43 may comprise the fiber cement gypsum article of any one of embodiment 36 or embodiment 37, wherein the aesthetic finish comprises a laminated layer which is bonded to at least one surface of the fiber cement gypsum article.

Embodiment 44 may comprise a method for manufacturing a fiber cement gypsum composite article comprising any one of the preceding fiber cement gypsum composite formulations of embodiments 1 to 43 using the Hatschek process comprising the steps of:
a) forming a fiber cement gypsum slurry comprising at least a binder, a pozzolanic material and reinforcing fibers; and
b) depositing one or more thin layers of fiber cement gypsum slurry using the Hatschek process to form a building article having a desired thickness.

Embodiment 45 may comprise the method for manufacturing a fiber cement gypsum composite article of embodiment 44 comprising the further step of pressing the fiber cement gypsum article before curing.

Embodiment 46 may comprise the method for manufacturing a fiber cement gypsum composite article of any one of embodiment 44 or embodiment 45, comprising the further step of pressing the fiber cement gypsum article before curing wherein the fiber cement gypsum article is a green sheet and pressing is at a pressure range of between approximately 15 MPa and approximately 25 MPa for a period of between approximately 5 mins and approximately 10 mins.

Embodiment 47 may comprise the method for manufacturing a fiber cement gypsum composite article of any one of embodiment 44 or embodiment 46, comprising the further step of curing at a temperature of between approximately 60° C. and approximately 80° C., whilst at between approximately 90% and 100% relative humidity for a period of between approximately 18 and approximately 24 hours.

Embodiment 48 may comprise the method for manufacturing a fiber cement gypsum composite article of any one of embodiment 44 or embodiment 47, comprising the further step of pre-curing the fiber cement gypsum composite article at ambient temperature for a period of approximately 6 and approximately 12 hours before curing at a temperature of between approximately 60° C. and approximately 80° C., whilst at between approximately 90% and 100% relative humidity for a period of between approximately 18 and approximately 24 hours. Embodiment 49 may comprise the method for manufacturing a fiber cement gypsum composite article as of any one of embodiment 44 or embodiment 48, comprising the further step of drying a cured fiber cement gypsum composite article for a period of between approximately 30 and approximately 60 minutes at a temperature of between approximately 60° C. and approximately 80° C., whilst at less than approximately 10% relative humidity.

Although the embodiments have been described with reference to specific examples, it will be appreciated by those skilled in the art that the disclosure may be embodied in many other forms.

It is also contemplated that various combinations or sub-combinations of the specific features and aspects of the embodiments may be made and still fall within the scope of the disclosure. Accordingly, it should be understood that various features and aspects of the disclosed embodiments can be combined with or substituted for one another in order to form varying modes of the disclosed embodiment. Thus, it is intended that the scope of the present disclosure herein disclosed should not be limited by the particular disclosed embodiments described above, but should be determined only by a fair reading of the claims that follow.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

1. A fiber cement gypsum composite formulation comprising a binder, reinforcing fibers, and a pozzolanic material, wherein the binder comprises a gypsum-cement mix comprising gypsum and a hydraulic cement, wherein the gypsum comprises calcium sulfate dihydrate, and wherein the hydraulic cement comprises Portland cement.

2. The fiber cement gypsum composite formulation of claim 1, wherein the gypsum-cement mix comprises between approximately 50 to 75 wt % of a total wt % of the fiber cement gypsum composite formulation.

3. (canceled)

4. The fiber cement gypsum composite formulation of claim 1, wherein the gypsum comprises between approximately 30 to 45 wt % of a total wt % of the fiber cement gypsum composite formulation such that the gypsum-cement mix comprises between approximately 50 to 75 wt % of a total wt % of the fiber cement gypsum composite formulation.

5. (canceled)

6. The fiber cement gypsum composite formulation of claim 1, wherein the gypsum comprises 35 to 40 wt % of a total wt % of the fiber cement gypsum composite formulation.

7. (canceled)

8. The fiber cement gypsum composite formulation of claim 1, wherein the hydraulic cement comprises approximately 20 to 30 wt % of a total wt % of the fiber cement gypsum composite formulation such that the gypsum-cement mix comprises between approximately 50 to 75 wt % of a total wt % of the fiber cement gypsum composite formulation.

9. (canceled)

10. The fiber cement gypsum composite formulation of claim 1, wherein a wt % ratio of gypsum to hydraulic cement in the gypsum-cement mix ranges between approximately 1:1 and 2:1.

11. (canceled)

12. The fiber cement gypsum composite formulation of claim 1, wherein the reinforcing fibers comprise between approximately 7 to 10 wt % of a total wt % of the fiber cement gypsum composite formulation.

13. The fiber cement gypsum composite formulation of claim 1, wherein the reinforcing fibers are selected from the group consisting of cellulose fibers, synthetic fibers, polypropylene fibers, mineral fibers, basalt fibers, and combinations thereof.

14. (canceled)

15. (canceled)

16. (canceled)

17. The fiber cement gypsum composite formulation of claim 1, wherein the reinforcing fibers comprise approximately 4 wt % of cellulose fibers and approximately 2 wt % synthetic fibers, wherein the synthetic fibers are polypropylene fibers.

18. The fiber cement gypsum composite formulation of claim 1, wherein the pozzolanic material comprises metakaolin or silica fume.

19. The fiber cement gypsum composite formulation of claim 1, wherein the pozzolanic material comprises between approximately 5 to 11 wt % of a total wt % of the fiber cement gypsum composite formulation.

20. (canceled)

21. (canceled)

22. (canceled)

23. The fiber cement gypsum composite formulation of claim 1, further comprising a filler material.

24. The fiber cement gypsum composite formulation of claim 23, wherein the filler material comprises limestone or silica.

25. The fiber cement gypsum composite formulation of claim 23, wherein the filler material comprises between approximately 0 to 31 wt % of a total wt % of the fiber cement gypsum composite formulation.

26. The fiber cement gypsum composite formulation of claim 1, further comprising a low-density modifying agent.

27. The fiber cement gypsum composite formulation of claim 26, wherein the low-density modifying agent comprises expanded perlite.

28. The fiber cement gypsum composite formulation of claim 27, wherein the low-density modifying agent comprises approximately 5 wt % of a total wt % of the fiber cement gypsum composite formulation.

29. The fiber cement gypsum composite formulation of claim 26, wherein the low-density modifying agent further comprises approximately 13 to 28 wt % silica relative to a total wt % of the fiber cement gypsum composite formulation.

30. (canceled)

31. (canceled)

32. A fiber cement gypsum article comprising a fiber cement gypsum composite formulation of claim 1.

33. (canceled)

34. A fiber cement gypsum article as claimed in claim 32, wherein the fiber cement gypsum article further comprises one or more of: an intumescent coating material; a smooth or a textured surface; an aesthetic finish on at least a section of at least one major face of the fiber cement gypsum article.

35. (canceled)

36. (canceled)

37. A fiber cement gypsum article as claimed in claim 32, wherein the fiber cement gypsum article comprises an aesthetic finish on at least a section of at least one major face of the fiber cement gypsum article, wherein the aesthetic finish comprises one or more of: the group comprising textures, patterns, profiles, visual indicia and/or a decorative finish in the form of an applied coating material including for example, sealer, primer, paint or a digital print; a printed aesthetic finish; an embossed aesthetic finish; an integrally formed aesthetic finish; a machined aesthetic finish; a laminated layer bonded to at least one surface of the fiber cement gypsum article.

38. (canceled)

39. (canceled)

40. (canceled)

41. (canceled)

42. (canceled)

43. (canceled)

44. A method for manufacturing a fiber cement gypsum composite article as claimed in claim 1 using the Hatschek process comprising the steps of:
a) forming a fiber cement gypsum slurry comprising at least a binder, a pozzolanic material and reinforcing fibers; and
b) depositing one or more thin layers of fiber cement gypsum using the Hatschek process to form a building article having a desired thickness.

45. A method for manufacturing a fiber cement gypsum composite article as claimed in claim 44 comprising one or more of the further step of: pressing the fiber cement gypsum article before curing; pressing the fiber cement gypsum article before curing wherein the fiber cement gypsum article is a green sheet and pressing is at a pressure range of between approximately 15 MPa and approximately 25 MPa for a period of between approximately 5 mins and approximately 10 mins; curing at a temperature of between approximately 60° C. and approximately 80° C., whilst at between approximately 90% and 100% relative humidity for a period of between approximately 18 and approximately 24 hours; pre-curing the fiber cement gypsum composite article at ambient temperature for a period of approximately 6 and approximately 12 hours before curing at a temperature of between approximately 60° C. and approximately 80° C., whilst at between approximately 90% and 100% relative humidity for a period of between approximately 18 and approximately 24 hours; drying a cured fiber cement gypsum composite article for a period of between approximately 30 and approximately 60 minutes at a temperature of between approximately 60° C. and approximately 80° C., whilst at less than approximately 10% relative humidity.

46. (canceled)

47. (canceled)

48. (canceled)

49. (canceled)
